(19) United States
(12) Patent Application Publication
(10) Pub. No.: US 2024/0270290 A1
(43) Pub. Date: Aug. 15, 2024

(54) ROBOT SYSTEM WITH A MOVABLE ROBOT

(71) Applicant: Maik Hermanns, Burgdorf (DE)

(72) Inventor: Maik Hermanns, Burgdorf (DE)

(21) Appl. No.: 18/569,111

(22) PCT Filed: Jun. 8, 2022
(86) PCT No.: PCT/DE2022/100431

§ 371 Date: Dec. 11, 2023

(30) Foreign Application Priority Data
Jun. 9, 2021 (DE) 10 2021 114 914.2

(51) Int. Cl. B61C 11/04; B25J 5/02; B25J 13/08; B25J 19/00; B61C 3/00; B61L 25/02; B61L 27/57; E01B 25/04; E04G 21/14

(52) U.S. Cl. CPC B61C 11/04; B25J 5/02; B25J 13/088; B25J 19/0029; B61C 3/00; B61L 25/02; B61L 27/57; E01B 25/04; E04G 21/14

(57) ABSTRACT

A robot system has a movable robot and a track guiding the robot during movement thereof with at least two guides. The track contains at least one drive element with a toothed driving profile, and the robot contains at least one drive wheel which is operatively connected to a motor drive unit of the robot and engages in the toothed driving profile during movement of the robot in the track.

### FIELD OF THE INVENTION

The invention relates to a robot system with a movable robot and a track guiding the robot during movement with at least two guides.

The invention also relates to the use of a robot system as a construction automation system.

### PRIOR ART

A robot system with a movable robot is already known from DE 10 2007 005 029 A1. In this robot system, the robot has, in addition to a robot arm, a self-propelled workpiece carrier, on which the robot arm is mounted. The workpiece carrier is guided on a rail system with a guide roller, which allows the robot to be moved in the X-Y direction on the rail system. The known robot system can also operate in the Z direction using the robot arm of the robot. However, the disadvantage of the known robot system is that the range with which the system can operate in the Z direction, i.e. in the vertical direction, is limited.

### STATEMENT OF OBJECT

It is therefore the object of the present invention to provide an improved robot system, in particular a robot system with significantly improved operability in the vertical direction.

### EXPLANATION OF THE INVENTION

This object is achieved in conjunction with the features of the preamble of claim 1 in that the track has at least one drive element with a drive tooth profile, and the robot comprises at least one drive wheel which is operatively connected to a motor drive unit of the robot and engages in the drive tooth profile during the movement of the robot in the track.

The dependent claims relate to preferred embodiments.

A further independent claim is directed to the use of the robot system according to the invention as a construction automation system.

In the robot system according to the invention, the robot can thus also move up in a vertical direction and thus, e.g., on a building wall. In other words, the track can therefore also be at least partially or even completely vertically oriented, without this restricting the functionality of the robot system. In the case of an at least partially vertical orientation, the track does not necessarily have to run in the vertical direction, but has an incline, whereas, in the case of a completely vertical orientation of the track, it runs in the vertical direction.

As a result, the robot of the robot system according to the invention also no longer necessarily has to have a robot arm, as in the system known from the prior art, in order to be able to operate in the Z direction, i.e. in the vertical direction. Rather, the robot of the system according to the invention can also operate without a robot arm in the Z direction, since it can also travel along at least partially or even completely vertically oriented tracks without any problems due to its design according to the invention and the inventive design of the track.

In the present invention, the robot can thus also be, for example, a transport robot set up to transport workpieces. Additionally or alternatively, however, the robot may also have a tool, such as a material processing tool and/or a material application tool, and/or a robot arm. In the present invention, the drive element may comprise, for example, a toothed rack and/or a toothed belt or be a toothed rack or a toothed belt.

Since the robot of the robot system according to the invention can also travel along a partially or completely vertically oriented track without any problems, it has significantly improved operability in the vertical direction compared to previously known systems. Due to the possibility of dispensing with a separate robot arm while simultaneously maintaining operability in the vertical direction, the required design effort for the robot system according to the invention is also significantly minimized compared to known systems. The robot system according to the invention is therefore more cost-effective to manufacture and is also distinguished by a significantly reduced maintenance effort.

Quite generally, the robot system according to the invention can of course also have a plurality of, preferably e.g. at least 2, at least 3, at least 4, at least 5, at least 6, at least 7, at least 8, at least 9, at least 10, at least 15 and/or at least 25, robots according to the invention.

The robot system may also have or be, for example, a two-axis system in the form of an X-Y table which is also referred to as an area gantry. Here, for example, one of the axes of the two-axis system can be at least partially or completely vertically oriented. Preferably, the robot of the robot system is one of the axis drives of the two-axis system or one of the axis drives of the two-axis system comprises a robot of the robot system. If the robot system has a plurality of robots according to the invention, each of the axis drives of the two-axis system can also each have or be in this case, for example, a robot according to the invention.

The robot system may also have or be, for example, a three-axis system in the form of an X-Y-Z table which is also referred to as a three-dimensional gantry. Here, for example, one of the axes of the three-axis system can be at least partially or completely vertically oriented. Preferably, the robot of the robot system is one of the axis drives of the three-axis system or one of the axis drives of the three-axis system comprises a robot of the robot system. If the robot system has a plurality of robots according to the invention, each of the axis drives of the three-axis system can also each have or be in this case, for example, a robot according to the invention.

In order to improve the operability in the vertical direction even further, one preferred embodiment of the present invention provides for the guides of the track to each have a guide tooth profile and for the robot to comprise, for each of the guides, at least one guide wheel which engages in the guide tooth profile of the respective guide when the robot moves in the track. As a result, the robot is additionally advantageously secured against unintentionally falling out of the track during movement in a partially or completely vertical direction. In addition, the guide wheels can be used, for example, to secure the robot at a working position. For example, by bracing the guide wheels in a force-fitting manner against the respective guide or the guide tooth profile of the respective guide, e.g. by means of one or more suitable electric motors.

For this purpose, it is particularly advantageous if, as is provided in a further preferred embodiment of the present invention, at least one of the guide tooth profiles is arranged on an inside of the respective guide oriented toward a center of the track.

A further preferred embodiment of the invention provides for at least one of the guides to comprise a circular arc profile having the guide tooth profile of this guide. Of course, the guides of the track can also each have such a circular arc profile.

In this embodiment, it is advantageous that, as a result, engagement of the corresponding guide wheel in the guide tooth profile, for example for the force-fitting bracing already mentioned, can be produced particularly easily, in particular without the risk of undesired snagging, and can also be released again. The guide wheel or the guide wheels can also be countersunk, e.g. in a housing of the robot, after the engagement in the respective guide wheel profile has been released, and/or can be arranged in this/a housing of the robot before the engagement is established.

In a further preferred embodiment of the present invention, the establishment and release of the engagement of the guide wheel is improved even further by at least one of the guides having a trapezoidal profile having two base sides and two trapezoidal limbs, and one of the two base sides of the trapezoidal profile having the guide tooth profile of this guide. Of course, the guides of the track can also each have such a trapezoidal profile.

The inventor has also found that the maintenance effort required for the robot system can be further significantly reduced if, as is provided in a further preferred embodiment of the present invention, the guide having the trapezoidal profile comprises at least one tooth 8 intermediate space which has a chamfer that is not parallel to one of the two base sides. Preferably, the guide tooth profile of this guide has the tooth intermediate space. This prevents dirt, such as abrasion dust or dust, which usually accumulates on the guide during operation, from collecting, especially in the guide tooth profile of the guide. Rather, this dirt is pressed out of the guide tooth profile or the guide by the chamfer provided according to the invention in this embodiment during the movement of the robot, whereby the robot system cleans itself in an advantageous manner during operation. Maintenance times and thus downtimes are thus advantageously minimized.

Particularly preferably, the tooth intermediate space has at least two chamfers extending in different directions, whereby the self-cleaning effect described can be advantageously increased even further. Additionally or alternatively, the tooth intermediate space may also have an aperture. This allows debris and dirt to be pushed out of the tooth intermediate space through the aperture, which advantageously minimizes the risk of unwanted accumulation of contaminants even further.

The robot system according to the invention can also be additionally or alternatively protected from unwanted contaminants by further measures. For example, the track and/or the secondary track and/or at least one of the guides and/or at least one of the secondary guides may have at least one hole through which a contaminant can be moved out of the track and/or the at least one guide and/or the at least one secondary guide by means of a travel movement 6 of the robot. Preferably, the hole is an aperture. Additionally or alternatively, the robot may comprise a cleaning apparatus. The cleaning apparatus may have, for example, a dust wiper ring and/or a broom, in particular a broom rhombus. Additionally or alternatively, the cleaning apparatus can be arranged at least partially or completely, for example, on at least one of the wheels of the robot, in particular on a wheel underside, and/or on a sliding contact of the robot.

A further preferred embodiment of the present invention provides for the track to have a U-shaped profile with two limbs and a base.

The base may include, for example, a track base of the track or may be a track base of the base. The U-shaped profile of the track is advantageous, since this already has good guiding properties for the robot simply due to the structural design of the track.

It is particularly preferred here, as is provided in a further preferred embodiment of the present invention, that the guides are arranged on the limbs of the U-shaped profile and/or the limbs each have one of the guides.

In the present invention, the track may be curved and/or straight, for example. In the case of a curved track, the robot preferably has, for a first of the guides, at least one guide wheel which engages in the guide tooth profile of this guide during the movement of the robot in the track, and has, for the other, second guide, at least two guide wheels which each engage in the guide tooth profile of this second guide during the movement of the robot in the track, wherein the number of guide wheels of the robot for the first and the second guide differ from each other and/or the number of guide wheels of the robot for the second guide is greater than the number of wheels for the first guide. Additionally or alternatively, the robot may have, for example, twice as many wheels for the second guide as for the first guide, and/or the first guide has exactly one guide wheel and/or the second guide has exactly two guide wheels. This makes it possible for the robot to move along in particular curved tracks particularly well.

However, it is also possible for the robot to be configured to turn off from the track into a secondary track branching off from the track. One preferred embodiment provides, for example, for the robot system to comprise a secondary track which branches off from the track and has at least two secondary guides guiding the robot in the secondary track.

For example, the secondary track can be structurally designed in accordance with the track. A further preferred embodiment provides, for example, for the secondary track to have at least one secondary drive element with a secondary drive tooth profile, and for the robot to comprise at least one secondary drive wheel which is operatively connected to the motor drive unit of the robot and engages in the secondary drive tooth profile during the movement of the robot in the secondary track, and for the robot to be configured to release the engagement of the drive wheel in the drive tooth profile and to bring the secondary drive wheel into engagement with the secondary drive tooth profile when branching off from the track into the secondary track.

The robot system can also have a plurality of, e.g. at least 2, at least 3, at least 4, at least 5, at least 6, at least 7, at least 8, at least 9, at least 10, at least 12, at least 15, at least 20, at least 25, secondary tracks according to the invention. Additionally or alternatively, the robot system can also have, for example, a plurality of, e.g. at least 2, at least 3, at least 4, at least 5, at least 6, at least 7, at least 8, at least 9, at least 10, at least 12, at least 15, at least 20, at least 25, tracks according to the invention. Preferably, at least one, a plurality of or all tracks is/are orthogonal to the or at least one of the secondary tracks.

A further preferred embodiment provides for the secondary guides to each have a secondary guide tooth profile, and for the robot to comprise, for each of the secondary guides, at least one secondary guide wheel which engages in the secondary guide tooth profile of the respective secondary guide during the movement of the robot in the secondary track, and for the robot to be configured to release the engagement of the guide wheels in the respective guide tooth profile and to bring the secondary guide wheels into engagement with the respective secondary guide tooth profile when branching off from the track into the secondary track.

As already explained, the guide wheel or the guide wheels can be advantageously brought into engagement with the guide tooth profile of the respective guide, e.g. for the force-fitting bracing already mentioned. However, this concept according to the invention is of course not only limited to the guide wheel or the guide wheels, but can also be advantageously used for other wheels of the robot of the present invention.

A further preferred embodiment of the present invention therefore provides for the robot to be configured to bring the drive wheel and/or one of the guide wheels and/or the guide wheels and/or the secondary drive wheel and/or one of the secondary guide wheels and/or the secondary guide wheels into engagement with at least one track tooth profile of the track surface and/or a secondary tooth profile of the secondary track and to release this engagement again.

It is particularly advantageous if, when branching off from the track into the secondary track, the existing engagement of the drive wheel in the drive tooth profile at a drive wheel engagement position is released by moving the drive wheel from the drive wheel engagement position into a drive wheel bearing position located above and/or laterally offset from the drive wheel engagement position. In the drive wheel bearing position, the drive wheel can be arranged, for example, at least partially, preferably completely, within a housing of the robot. The movement into the drive wheel bearing position or the arrangement within the housing advantageously prevents the drive wheel, which is no longer in engagement with the drive tooth profile, from interfering with or even preventing the turning-off process, e.g. by an unwanted stop on the track or the secondary track.

For example, the drive wheel can be moved linearly from the drive wheel engagement position into the drive wheel bearing position. In the present invention, however, the drive wheel is preferably moved helically from the drive wheel engagement position into the drive wheel bearing position. For this purpose, the drive wheel may be arranged e.g. eccentrically on a pin with a helical external thread, wherein the pin forms a matching pair of threads with a corresponding helical internal thread, which, for example, a housing of the robot may have. In this arrangement, the drive wheel can be moved helically from the drive wheel engagement position into the drive wheel bearing position by turning the pin in one direction, e.g. clockwise, and thus the engagement of the drive wheel in the drive tooth profile can be released. By turning the pin in the opposite direction, e.g. counterclockwise, the drive wheel can then be moved back helically from the drive wheel bearing position into the drive wheel engagement position again and thus the drive wheel can be brought into engagement with the drive tooth profile again. For the term helical, the synonymous terms spiral or helix-shaped are also often used. Of course, this concept according to the invention is also not only limited to the drive wheel, but can also be used additionally or alternatively in one or more of the other wheels of the robot of the present invention. For example, this concept according to the invention can also be accordingly applied, for example, to one of the guide wheels and/or the guide wheels and/or the secondary drive wheel and/or one of the secondary guide wheels and/or the secondary guide wheels.

It is also advantageous, for example, in the invention, if, when branching off from the track into the secondary track, the existing engagement of one of the guide wheels in the respective guide tooth profile at a guide wheel engagement position is released by moving this guide wheel from the guide wheel engagement position into a guide wheel bearing position located above and/or laterally offset from the guide wheel engagement position. In the guide wheel bearing position, the guide wheel can be arranged, for example, at least partially, preferably completely, within a housing of the robot. The movement in the guide wheel bearing position or the arrangement within the housing advantageously prevents the guide wheel, which is no longer in engagement with the respective guide tooth profile, from interfering with or even preventing the turning-off process, e.g. by an unwanted stop on the track or the secondary track.

For example, the guide wheel can be moved linearly from the guide wheel engagement position into the guide wheel bearing position. However, in the present invention, the guide wheel is preferably moved helically from the guide wheel engagement position into the guide wheel bearing position. For this purpose, the guide wheel may be arranged e.g. eccentrically on a pin with a helical external thread, wherein the pin forms a matching pair of threads with a corresponding helical internal thread, which, for example, a housing of the robot may have. In this arrangement, the guide wheel can be moved helically from the guide wheel engagement position into the guide wheel bearing position by turning the pin in one direction, e.g. clockwise, and thus the engagement of the guide wheel in the guide tooth profile can be released. By turning the pin in the opposite direction, e.g. counterclockwise, the guide wheel can then be moved back helically from the guide wheel bearing position into the guide wheel engagement position again and thus the guide wheel can be brought into engagement with the guide tooth profile again.

In addition, it is advantageous if the wheel or the wheels of the robot also contribute (s) to stable guidance of the robot within the track or the secondary track due to their structural design. A further preferred embodiment of the invention therefore provides for the robot to have at least one wheel having an engagement region, which is configured to engage in a tooth profile of a tooth profile-bearing element, and a guide element which guides the wheel on the tooth profile-bearing element during a rotational movement of the wheel.

It has already been explained that dirt, such as abrasion dust or dust, has an unfavorable effect on the resulting required maintenance times and downtimes of the robot system. So that the wheel or wheels of the robot can advantageously clean itself/themselves during operation, a further preferred embodiment of the present invention therefore provides for the engagement region to have an engagement region tooth intermediate space, and for the guide element to have an aperture connected to the engagement region tooth intermediate space. As a result, dirt is pressed out of the engagement region tooth intermediate spaces through the aperture during operation, whereby the robot system cleans itself in an advantageous manner during operation.

A further preferred embodiment of the invention provides, for example, for the wheel having such an aperture to be the drive wheel and/or one of the guide wheels and/or the secondary drive wheel and/or one of the secondary guide wheels.

In the present invention, the guides and the drive element can of course be separate components. However, the properties of these components can advantageously also be combined in one component which, in the context of a dual function, performs both the function of at least one of the guides and the function of the drive element. This reduces the total number of components required for the robot. The robot system is therefore more compact, has a structurally simpler design and is also more cost-effective to manufacture. One preferred embodiment therefore provides for one of the guides to be the drive element, for the guide tooth profile of this guide to be the drive tooth profile, and for the guide wheel engaging in the guide tooth profile of this guide to be the drive wheel.

This principle can also be applied additionally or alternatively to at least one of the secondary guides. A further preferred embodiment of the present invention therefore provides for one of the secondary guides to be the secondary drive element, for the secondary guide tooth profile of this secondary guide to be the secondary drive tooth profile, and for the secondary guide wheel engaging in the secondary guide tooth profile of this secondary guide to be the secondary drive wheel.

In principle, the robot or robots of the robot system according to the invention can be configured, for example, for wireless data communication and/or wireless energy consumption. The wireless energy consumption can take place inductively, for example, in particular from the track and/or the secondary track. However, the inventor has found that, especially when used in the industrial sector, numerous interference signals severely interfere with wireless data communication in robot systems. One preferred embodiment of the present invention therefore provides for the track to have a data line, and for the robot system to have a communication device which is configured for data communication with the robot via the data line. The data communication device and/or the data line can be configured in the present invention, for example, for radio-frequency data communication.

Data communication between the data line and the robot can take place, for example, wirelessly, e.g. by means of an antenna, a near-field coupler and/or a directional coupler element of the robot. The directional coupler element can form a directional coupler together with the data line, for example.

In this case, it is particularly advantageous if, as is provided in a further preferred embodiment of the present invention, the robot system has an energy supply device which is configured to supply the robot with electrical energy via the data line. In other words, in this embodiment, the data line thus has a dual function as a data and energy line. Preferably, in the case of the data line, a data signal and the electrical energy for supplying the robot, e.g. for its motor drive unit and/or its tools, are transported via a common electrical conductor of the data line.

In the present invention, as is provided in one preferred embodiment of the invention, the data line may comprise, for example, an open data line section not completely surrounded by a shield and/or a strip line. The data line has a plurality of open data line sections not completely surrounded by a shield, e.g. if it is in the form of a leaky waveguide. In this embodiment, the strip line may have, for example, one or more electrical conductors, e.g. in the form of electrically conductive strips, which are applied to a dielectric. The dielectric can be, for example, a chemical fixing agent, such as an adhesive.

Preferably, the strip line is a microstrip line in which the electrical conductor (s) is/are separated by the dielectric from an electrically conductive ground plane.

A further preferred embodiment provides for the drive element and/or the drive tooth profile to comprise the data line. Here it is advantageous that the drive element or the drive tooth profile simultaneously also acts as a data line according to the invention. This dual function no longer requires a data line to be provided separately to the drive element and/or to the drive tooth profile. For example, the drive element in this embodiment may be a modified toothed belt and/or a modified toothed rack having a strip line structure. For this purpose, e.g. an electrical conductor can be milled into the toothed belt which otherwise acts as a dielectric. Optionally, an electrically conductive ground plane can also be arranged here underneath the toothed belt, with the result that the toothed belt modified in this way has a microstrip line structure. Accordingly, for example, one of the guides and/or the guide tooth profile of one of the guides can also simultaneously act as a data line according to the invention.

A further preferred embodiment therefore provides for one of the guides and/or the guide tooth profile of one of the guides to comprise the data line.

The inventor has found that, regardless of how the data line according to the invention is structurally designed, in the case of a secondary data line branching off from the data line or a plurality of secondary data lines branching off from the data line, signal losses occur at these branches, in particular with data signals. The inventor has found that these signal losses are due to the fact that the branches of the secondary data line or the secondary data lines at the branches cause a change in the impedance on the respective branches. This problem has been solved by the inventor in a further embodiment of the invention in that the robot system comprises a secondary data line electrically connected to a branching region of the data line,
wherein the branching region of the data line has a branching impedance, and a normal region of the data line arranged upstream of the branching region has a normal impedance, and
an impedance modification element that matches the branching impedance to the normal impedance is electrically connected to the branching region. The normal region is arranged, for example, in terms of circuitry between the communication device and the branching region.

The impedance modification element may here include, for example, one or more discrete components, such as coils and/or capacitors, or consist of these. However, the process of establishing the electrical connection between the impedance modification element and the branching region is complicated in this case, since the discrete components would have to be soldered in, for example. However, the inventor has found a solution in which the use of discrete components can be completely dispensed with, in principle.

A further preferred embodiment therefore provides for the secondary data line to have a main section and a modification section structurally modified compared to the main section, and for the modification section to be the impedance modification element. This is because the inventor has found that, instead of discrete components, the impedance modification required at the branches can also be achieved by the structural design of the secondary data line itself. For this purpose, the modification section of the secondary data line can be, for example, an electrical line designed as a lambda quarter transformer and designed to be narrower than the main section. Due to the narrower design, the modification section therefore also has a higher impedance at the same time. Additionally or alternatively, the modification section may also be designed, for example, as a Wilkinson coupler, which is also known as a Wilkinson splitter, and/or as a branch line coupler.

In the present invention, the data line and/or at least one of the data lines and/or the secondary data line and/or one of the secondary data lines, for example, can be terminated with a terminating resistor which is decoupled by means of a capacitor from an energy supply voltage applied to the respective line.

A further preferred embodiment of the invention provides for the secondary track to have the secondary data line. This embodiment is particularly advantageous in connection with a further preferred embodiment of the invention, which provides for the secondary drive element and/or the secondary drive tooth profile to comprise the secondary data line. In this case, the secondary drive element or the secondary drive tooth profile advantageously has a dual function, since it also simultaneously acts as a secondary data line according to the invention. This reduces the number of components required for the robot system, as a result of which its structure can be advantageously simplified and its manufacturing costs reduced.

The same also applies in a further preferred embodiment of the invention which provides for one of the secondary guides and/or the secondary guide tooth profile of one of the secondary guides to comprise the secondary data line.

The robot (s) of the robot system according to the invention is/are preferably supplied with electrical energy via the data line in the invention, as already explained. Energy can be supplied here, for example, contactlessly via an energy supply element of the robot and/or by means of contact between the energy supply element and the data line. The energy supply element can be realized e.g. as a sliding contact of the robot, which can be a carbon brush, for example. Preferably, however, one of the wheels of the robot, e.g. the drive wheel and/or one of the guide wheels and/or the secondary drive wheel and/or one of the secondary guide wheels, is the energy supply element.

Regardless of how the energy supply element is structurally designed, a further preferred embodiment of the present invention provides for the robot to have an energy supply element configured to receive electrical energy, and for the communication device to be configured to use a frequency for data communication, at which the energy supply element acts as a radio-frequency idle state. In this embodiment, it is advantageous that the energy supply element, which, as explained above, can also be one of the wheels of the robot, acts as a radio-frequency idle state.

For this purpose, the energy supply element can be a lambda quarter transformer, for example. This can be achieved, for example, by selecting a suitable wheel geometry. In other words, in this embodiment, the geometry of the energy supply element is thus tuned to the frequency used for data communication in such a way that the energy supply element acts as a radio-frequency idle state or as a lambda quarter transformer. This is particularly advantageous, since the energy supply element thereby does not interfere with the data communication taking place via the data line. Of course, in the present invention, the data communication between the communication device and the robot via the data line can also take place via the energy supply element, e.g. via an additional coupling-out point of the energy supply element.

In the present invention, the robot system may have a position determination device configured to determine a position of the robot within the robot system. The position determination device may be configured, for example, to determine the position of the robot during a journey of the robot and/or when the robot is at a standstill.

A further preferred embodiment of the invention provides for the robot system to have a position determination device configured to determine a position of the robot within the robot system, and
for the position determination device to be configured to determine the position of the robot when the robot is at a standstill. In the event of a cold start of the robot system, this eliminates the need for complex journeys by the robots in the search for limit switches mounted on the track or the secondary track. Rather, in this embodiment, the position of the robot or robots can be advantageously detected immediately in the event of a cold start. The position of the robot or robots can be realized e.g. via RFID transponders, optically, e.g. via cameras, and/or via markings applied to the track and/or the secondary track, such as magnetic strips having barcodes, QR codes and/or magnetic coding.

However, it is preferred in the present invention if, as is provided in a further preferred embodiment, the position determination device is configured to determine the position of the robot via the data line. It is advantageous in this case that the position determination via the data line is relatively interference-free. In this case, for example, the position can be determined via a UWB radar measurement (ultra-wideband radar measurement), a narrowband radar measurement and/or a time-of-flight measurement via the data line. Additionally or alternatively, the position can be determined, e.g., by means of active and/or passive radar transponders. In the present invention, active radar transponders which receive a measurement and/or identification signal, process it in at least one electronic component and send a response signal are preferably used.

In the present invention, for example, one or more robots and/or the track and/or the secondary track and/or at least one section of the track and/or at least one section of the secondary track of the robot system may have the active and/or passive radar transponders. Particularly preferably, in the present invention, both at least one robot and at least one of the tracks or the track and/or at least one of the secondary tracks or the secondary track each have at least one active and/or passive radar transponder. In this case, it is particularly preferred if at least one of the active transponders has a further, second position determination device. As a result, these position data determined by the second position determination device can advantageously be used to resolve position ambiguities in the position data from the first position determination device or generally to correct the position data determined by the first position determination device of the robot system. In this case, the second position determination device, like the first position determination device, can use for example active and/or passive radar transponders, preferably active radar transponders, which receive a measurement and/or identification signal, process it in at least one electronic component and send a response signal.

A further preferred embodiment of the invention provides for the track to have a modular structure consisting of a plurality of interconnected track modules. It is advantageous in this case that the track can be easily adapted to the conditions prevailing or possibly changing at a particular installation site or that the track can also be easily extended if necessary. This is advantageous, for example, if the robot system according to the invention is to be used as a construction automation system. In this case, the robot system can be configured for material processing and/or material application, for example. For example, the robot system can be placed on a building wall in order to apply paint to the building wall. In general, the robot system according to the invention is therefore preferably configured to treat a building wall.

In general, the robot system according to the invention can be used, for example, as a construction automation system. An independent claim is therefore directed to the use of the robot system according to the invention as a construction automation system.

A further preferred embodiment of the invention provides for the track modules to be telescopically and/or foldably connected to each other. It is advantageous in this case that the robot system can be easily adapted to the conditions prevailing at a new installation site.

A further preferred embodiment of the invention provides for the position determination device to be configured to determine a track module position of at least one of the track modules. Here it is advantageous that the position determination device can determine the position of the 8 track modules in addition to the robots, for example in the event of a cold start. This allows the position determination device, for example, to advantageously output a warning if one or more of the track modules is at an incorrect position, for example after dismantling and rebuilding the robot system at a new installation site, and, for example, can indicate to a user which of the track modules is at an incorrect position. For determining the position of the track module or the track modules, the position determination device can use, for example, the same measures already described for determining the position of the robots or robot.

A further preferred embodiment of the invention provides for the robot system and/or the robot to have a sensor which is configured to detect alignment errors of the robot system and/or to detect wear of a component of the robot system and/or of the robot. This is particularly advantageous with regard to safety aspects, since this makes it possible to detect alignment errors and wear and thus prevent accidents due to these factors in advance. The robot system can be configured, for example if an alignment error and/or wear is detected, to output a warning signal and/or advice for correcting the alignment error or wear and/or for an emergency shutdown.

A further preferred embodiment of the invention provides for the sensor to be a laser distance measurement sensor and/or a force sensor and/or a strain sensor and/or an inertial sensor and/or a laser position sensor. In this embodiment, it is advantageous that, for example, the laser-based sensors can also be used simultaneously to determine the position of the robot or robots and that load-dependent and/or assembly-dependent deflections of the axes can be corrected. Here, the robot system can be configured, for example, to correct these load-dependent and/or assembly-dependent deflections automatically, preferably immediately after their detection.

A further preferred embodiment of the invention provides for the robot system to comprise, in addition to the robot, a further, additional robot, and for the robot to have an additional track guiding the additional robot during movement with at least two additional guides,
wherein the additional track has at least one additional drive element with an additional drive tooth profile, and the additional robot comprises at least one additional drive wheel which is operatively connected to an additional motor drive unit of the additional robot and engages in the additional drive tooth profile during the movement of the additional robot in the additional track. In this embodiment, it is advantageous that the robot itself is a carrier of an additional track for the additional robot. This allows the additional track to be moved to any position within the robot by means of the robot. In other words, in this embodiment, the track course for the additional robot can thus be flexibly changed by moving the robot.

If the robot system has a plurality of robots, of course a plurality of robots, e.g. at least 2, at least 3, at least 4, at least 5, at least 6, at least 7, at least 8, at least 9, at least 10, at least 15 and/or at least 25 robots, may also each have an additional track according to the invention. In this embodiment, the additional robot can be designed, e.g. without the additional track, but otherwise in a structurally identical manner to the robot. In principle, however, it is also possible for the additional robot to be designed to be structurally identical to the robot and thus also have an additional track according to the invention. In other words, in this embodiment, the additional track may therefore also be designed, for example, to be structurally identical to the track and/or to the secondary track and/or to a section of the track and/or to a section of the secondary track.

The robot system according to the invention may also have at least one stationary robot, for example, in addition to the movable robot and/or the additional robot. The stationary robot can have, for example, a robot arm and/or be configured to transport workpieces. Additionally or alternatively, however, the stationary robot may also have a tool, such as a material processing tool and/or a material application tool.

The stationary robot can be connected to a track and/or a secondary track and/or an additional track within the meaning of the present invention, for example by means of a releasable connection, and/or can be configured to form a releasable connection to a track and/or a secondary track and/or an additional track within the meaning of the present invention. As a result, the stationary robot can be advantageously moved to a different position within the robot system in a particularly simple manner by releasing the releasable connection if necessary, and can be fixed there again by forming a correspondingly new releasable connection. A releasable connection is a connection that can be released again without damaging the components that are connected to one another. In the present invention, the releasable connection may be, for example, a force-fitting and/or form-fitting connection. The stationary robot can be connected to a track and/or a secondary track and/or an additional track lane within the meaning of the present invention, for example by means of bracing, in particular bracing realized via at least one of its wheels, and/or can be configured to form such a releasable connection to a track and/or a secondary track and/or an additional track of the robot system. For example, the possibility of force-fitting bracing already described for the movable robot can also be used correspondingly for the stationary robot in the context of the present invention.

The explanations and disclosures with respect to a constituent part of the robot system according to the invention also apply analogously to all other constituent parts of the robot system according to the invention, provided that these do not contradict the specific explanations and disclosures of the other constituent parts. For example, the explanations and disclosures with respect to the track according to the invention also apply analogously to the secondary track and the additional 27 track, provided that these do not contradict the specific explanations and disclosures made in connection with the secondary track and the additional track. The same also applies, for example, to the disclosures and explanations with respect to the drive element, which also apply analogously, for example, to the guides, the secondary guides, the additional guides, the secondary drive element and the additional drive element, provided that these do not contradict the specific explanations and disclosures made in connection with the guides, the secondary guides, the additional guides, the secondary drive element and the additional drive element.

In addition, the explanations and disclosures with respect to a subject matter according to the invention also apply analogously to all other subjects according to the invention, provided that these do not contradict the specific explanations and disclosures of the other subjects according to the invention. For example, the explanations and disclosures with respect to the robot system according to the invention also apply analogously to the use according to the invention, provided that these do not contradict the specific explanations and disclosures made in connection with the use according to the invention.

Further features and advantages of the invention emerge from the following specific description and the drawings.

### BRIEF DESCRIPTION OF THE FIGURES

### In the Drawings:

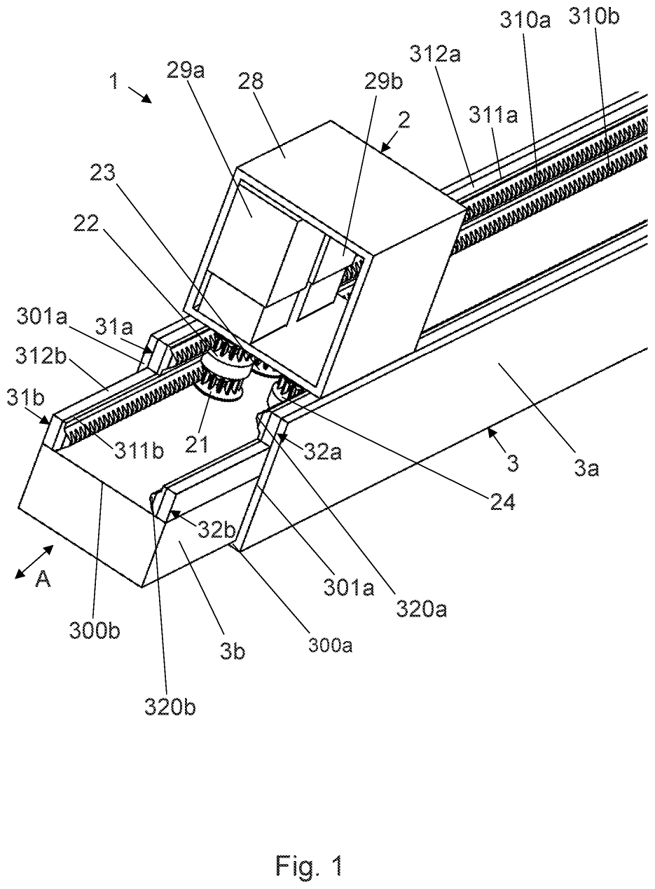

FIG. 1: shows a schematic illustration of a first embodiment of the present invention

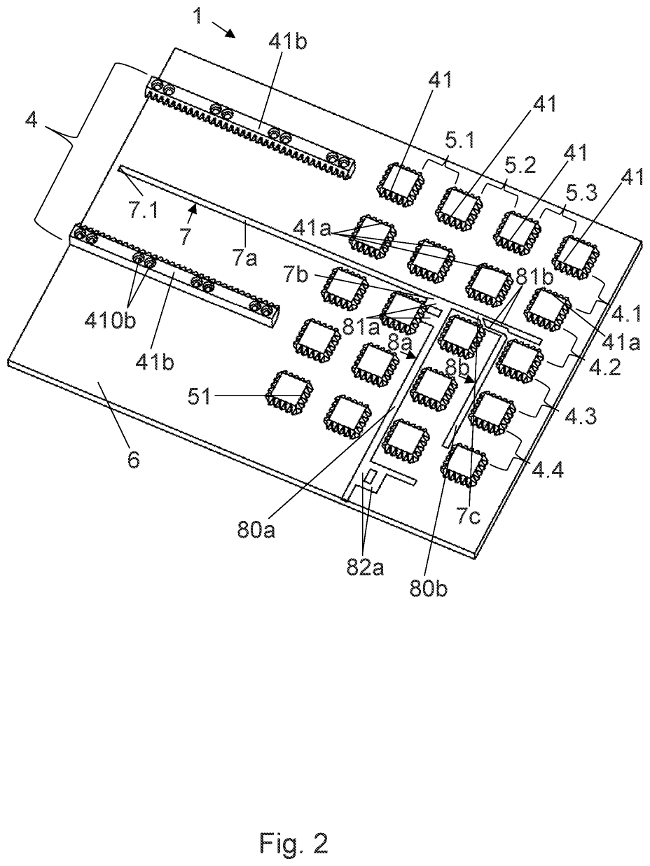

FIG. 2: shows a schematic illustration of a second embodiment of the present invention

### DESCRIPTION OF PREFERRED EMBODIMENTS

FIG. 1 shows a first embodiment of the robot system 1 according to the invention. The robot system 1 has a robot 2 and a track 3. The track 3 has a modular structure consisting of two track modules 3a, 3b which are pushed into one another and are connected to one another in a form-fitting manner. As indicated by the arrow A, the track module 3a can be pulled out of the track module 3b and pushed into the track module 3b again, as a result of which the track modules 3a and 3b are telescopically connected to each other. It can also be seen in FIG. 1 that the track module 3a has two guides 31a, 32a each with a guide tooth profile 310a, 320a and the track module 3b has two guides 31b and 32b each with a guide tooth profile 310b, 320b. Guide wheels 21, 22, 23 and 24 of the robot 2 respectively engage in the guide tooth profiles 310a, 320a, 310b, 320b. FIG. 1 also illustrates that the robot 2 has a housing 28, in which a motor drive unit formed from two electric motors 29a and 29b is arranged. The guide wheels 21 and 22 are operatively connected to the electric motor 29a, and the guide wheel 23 is operatively connected to the electric motor 29b. The guide wheel 24, on the other hand, is only rotatably fastened to the housing 28, but is not operatively connected to one of the electric motors 29a, 29b of the motor drive unit. The guide wheels 21, 22, 23 are thus simultaneously drive wheels of the robot 2. In this exemplary embodiment, therefore, the guides 31a, 31b are simultaneously also drive elements of the track 3.

It can also be seen in FIG. 1 that the track module 3b has a first U-shaped profile. In this case, a track base 300b of the track module 3b forms the base of this first U-shaped profile and the guides 31b and 32b form the limbs of this first U-shaped profile. In this exemplary embodiment, the limbs of the first U-shaped profile thus comprise the guides 31b and 32b. In the exemplary embodiment shown in FIG. 1, the track module 3a has a second U-shaped profile with two limbs 301a and a base formed by a track base 300a of the track module 3a. The guides 31a and 32a are respectively arranged on the limbs 301a.

In the exemplary embodiment shown in FIG. 1, the guides 31a and 31b are in the form of strip lines. The guide tooth profiles 310a and 310b are each produced from aluminum for this purpose and form the electrical conductor of the respective strip line. The strip lines also each have a ground plane 312a, 312b which is also produced from aluminum in this exemplary embodiment. A dielectric plastic layer 311a is arranged between the guide tooth profile 310a and the ground plane 312a. Accordingly, a dielectric plastic layer 311b is also arranged between the guide tooth profile 310b and the ground plane 312b.

The guides 31a and 31b, each in the form of strip lines, are each electrically connected to a communication device and an energy supply device of the robot system 1 in the exemplary embodiment illustrated in FIG. 1. For reasons of clarity, however, the communication device and the energy supply device are not illustrated in FIG. 1.

In this exemplary embodiment, the guide wheels 21, 22, 23 are produced from stainless steel and are electrically connected to the electric motors 29a and 29b. The electric motors 29a and 29b are supplied with electrical energy by the energy supply device via the guide tooth profiles 310a and 310b and via the guide wheels 21, 22 and 23. At the same time, the guides 31a and 31b, each in the form of strip lines, each serve as a data line of the robot system 1. For this purpose, in addition to the energy supply device, the communication device is also respectively electrically connected to the guide tooth profiles 310a and 310b which act as conductors. In this exemplary embodiment, the energy supply device is a power supply unit which feeds a DC voltage into the guide tooth profiles 310a and 310b via a power supply switch which is also not illustrated for reasons of clarity.

The communication device is disconnected from the DC voltage via a coupling capacitor of the power supply switch and communicates, via the coupling capacitor, via the guide tooth profiles 310a and 310b in the form of conductors and via the guide wheels 21, 22, 23, with an electronic control unit of the robot 2, which is arranged within the housing 28 and is not shown in FIG. 1 for reasons of clarity. For data communication, the communication device in this exemplary embodiment uses a frequency of 2.4 gigahertz (GHz). The geometry of the guide wheels 21, 22 and 23 is selected in such a way that they act as a lambda quarter transformer in relation to data communication, as a result of which the guide wheels 21, 22 and 23 are not interference points for data communication.

A second exemplary embodiment of the present invention is shown in FIG. 2. In FIG. 2, the illustration of the robot of the robot system 1 was omitted for reasons of clarity. The robot system which can be seen in FIG. 2 has a plurality of tracks 4, 4.1, 4.2, 4.3 and 4.4, wherein the track 4 is wider than the tracks 4.1, 4.2, 4.3 and 4.4. The track 4.1 has 8 guides 41, 41a each with a guide tooth profile. Here, the guides 41 are simultaneously also guides of the track 4. The guides 41b of the track 4 are screwed with screws 410b to the aluminum plate 6 serving in this exemplary embodiment as a track base or as a secondary track base. For reasons of clarity, only two screws 410b are provided with reference signs in FIG. 2. The secondary tracks 5.1, 5.2 and 5.3 also each have a plurality of secondary guides, wherein only the secondary guide 51 of the secondary track 5.1 is provided with a reference sign in FIG. 2 for reasons of clarity. For the same reason, the other guides of the tracks 4, 4.2, 4.3 and 4.4 are also not provided with reference signs in FIG. 2.

It can also be seen in FIG. 2 that a data line 7 is arranged in the track 4 and the track 4.2 and a secondary data line 8a, 8b is arranged in each of the secondary tracks 5.2 and 5.3. Only the conductor of the data line 7 and of the secondary data lines 8a, 8b is shown in each case in FIG. 2. Both the data line 7 and the secondary data line 8a, 8b are each in the form of a strip line in this exemplary embodiment. In this embodiment, the corresponding conductors are each separated by a dielectric from the aluminum plate 6 which in this case serves as a common ground plane for all strip lines. At the feed point 7.1, the data line 7 is connected to a communication device not shown in FIG. 2 and to an energy supply device not shown, which each communicate with the robot of the robot system 1 or supply it with electrical energy via the conductor of the data line 7 or via the conductors of the secondary data lines 8a, 8b.

The secondary data line 8a has a main section 80a and a modification section 81a which is in the form of a branch line coupler and is structurally modified in comparison with the main section 80a. In addition, it is also illustrated in FIG. 2 that the secondary data line 8b also has a main section 80b and a modification section 81b structurally modified in comparison with the main section 80b. The modification section 81b is designed in this case as a Wilkinson coupler. In addition, it can be seen in FIG. 2 that the secondary data line 8a has a further modification section 82a. Due to the modification sections 81a and 81b, the impedance at the branching regions 7b, 7c of the data line 7 corresponds to the impedance in the normal region 7a arranged upstream of the branching regions 7b, 7c.

In the exemplary embodiment shown in FIG. 2, a data line is arranged in each of the tracks 4, 4.1, 4.2, 4.3 and 4.4, and a secondary data line is arranged in each of the secondary tracks 5.1, 5.2 and 5.3, each of which are electrically connected to each other. As a result, the robot can travel on all tracks 4, 4.1, 4.2, 4.3 and 4.4 as well as the secondary tracks 5.1, 5.2 and 5.3, e.g. by branching off from the track 4.2 into the secondary track 5.2 at the branching region 7b, and the communication device can communicate with the robot at any position of the robot via the corresponding data and secondary data lines.

Of course, the embodiments discussed in the specific description and shown in the figures represent only illustrative exemplary embodiments of the present invention. In the light of the present disclosure, a wide range of possible variations is available to a person skilled in the art.

The same reference signs in the figures indicate the same or similar elements.

### LIST OF REFERENCE SIGNS

1 Robot system
2 Robot
3 Track
3a, 3b Track module
4, 4.1, 4.2, 4.3, 4.4 Track
5.1, 5.2, 5.3 Secondary track
6 Aluminum plate
7 Data line
7a Normal region
7b, 7c Branching region
7.1 Feed point
8a, 8b Secondary data line
21, 22, 23, 24 Guide gears
28 Housing
29a, 29b Electric motor
31a, 32a, 31b, 32b Guide
41, 41a, 41b Guide
51 Secondary guide
80a, 80b Main section
81a, 81b, 82a Modification section
300a, 300b Track base
301a Limb
310a, 320a, 310b, 320b Guide tooth profile
311a, 311b Dielectric plastic layer
312a, 312b Ground plane
410b Screws
A Arrow

1-37. (canceled)

38. A robot system, comprising:
a movable robot having a motor drive unit and at least one drive wheel being operatively connected to said motor drive unit of said movable robot; and
a track guiding said movable robot during movement and having at least two guides, said track having at least one drive element with a drive tooth profile, and said at least one drive wheel of said movable robot engaging in said drive tooth profile during the movement of said movable robot in said track.

39. The robot system according to claim 38, wherein:
said at least two guides of said track each have a guide tooth profile; and
said movable robot contains, for each of said at least two guides, at least one guide wheel which engages in said guide tooth profile of a respective one of said at least two guides during the movement of said movable robot in said track.

40. The robot system according to claim 39, wherein at least one of said guide tooth profiles is disposed on an inside of said respective guide oriented toward a center of said track.

41. The robot system according to claim 39, wherein at least one of said at least two guides has a circular arc profile which has said guide tooth profile of said at least one guide.

42. The robot system according to claim 39, wherein at least one of said at least two guides has a trapezoidal profile having two base sides and two trapezoidal limbs, and one of said two base sides of said trapezoidal profile has said guide tooth profile of said at least one guide.

43. The robot system according to claim 42, wherein said at least one guide having the trapezoidal profile contains at least one tooth intermediate space which has a chamfer that is not parallel to one of said two base sides.

44. The robot system according to claim 38, wherein said track has a U-shaped profile with two limbs and a base.

45. The robot system according to claim 44, wherein said at least two guides are disposed on said two limbs of said U-shaped profile, and/or said two limbs each have one of said at least two guides.

46. The robot system according to claim 39, further comprising a secondary track that branches off from said track and has at least two secondary guides guiding said movable robot in said secondary track.

47. The robot system according to claim 46, wherein:
said secondary track has at least one secondary drive element with a secondary drive tooth profile;
said movable robot contains at least one secondary drive wheel which is operatively connected to said motor drive unit of said movable robot and engages in said secondary drive tooth profile during the movement of said movable robot in said secondary track; and
said movable robot is configured to release an engagement of said at least one drive wheel in said drive tooth profile and bring said secondary drive wheel into engagement with said secondary drive tooth profile when branching off from said track into said secondary track.

48. The robot system according to claim 47, wherein:
said at least two secondary guides each have said secondary guide tooth profile; and
said movable robot has, for each of said at least two secondary guides, at least one said secondary guide wheel which engages in said secondary guide tooth profile of a respective one of said at least two secondary guides during the movement of said movable robot in said secondary track, and said movable robot is configured to release an engagement of guide wheels in a respective said guide tooth profile and bring said secondary guide wheels into engagement with a respective said secondary guide tooth profile when branching off from said track into said secondary track.

49. The robot system according to claim 47, wherein said movable robot is configured to bring said at least one drive wheel and/or one of said guide wheels and/or said guide wheels and/or said at least one secondary drive wheel and/or one of secondary guide wheels and/or said secondary guide wheels into engagement with at least one drive tooth profile of said track and/or said secondary drive tooth profile of said secondary track and to release this operation again.

50. The robot system according to claim 48, wherein said movable robot contains at least one wheel having an engagement region, which is configured to engage in a tooth profile of a tooth profile-bearing element, and a guide element which guides said wheel on said tooth profile-bearing element during a rotational movement of said at least one wheel.

51. The robot system according to claim 50, wherein said engagement region has an engagement region tooth intermediate space, and said guide element has an aperture connected to said engagement region tooth intermediate space.

52. The robot system according to claim 50, wherein said at least one wheel is said at least one drive wheel and/or one of said guide wheels and/or said secondary drive wheel and/or one of said secondary guide wheels.

53. The robot system according to claim 39, wherein one of said at least two guides is said at least one drive element, said guide tooth profile of said one guide is said drive tooth profile, and said at least one guide wheel engaging in said guide tooth profile of said one guide is said at least one drive wheel.

54. The robot system according to claim 48, wherein one of said at least two secondary guides is said at least one secondary drive element, said secondary guide tooth profile of said one secondary guide is said secondary drive tooth profile, and said at least one secondary guide wheel engaging in said secondary guide tooth profile of said one secondary guide is said at least one secondary drive wheel.

55. The robot system according to claim 47,
wherein said track has a data line; and
further comprising a communication device configured for data communication with said movable robot via said data line.

56. The robot system according to claim 55, further comprising an energy supply device configured to supply said movable robot with electrical energy via said data line.

57. The robot system according to claim 55, wherein said data line contains an open data line section not completely surrounded by a shield and/or a strip line.

58. The robot system according to claim 55, wherein said at least one drive element and/or said drive tooth profile contains said data line.

59. The robot system according to claim 55, wherein one of said at least two guides and/or said guide tooth profile of one of said at least two guides contains said data line.

60. The robot system according to claim 55, further comprising a secondary data line electrically connected to a branching region of said data line, wherein said branching region of said data line has a branching impedance, and a normal region of said data line disposed upstream of said branching region has a normal impedance, and an impedance modification element that matches the branching impedance to the normal impedance is electrically connected to said branching region.

61. The robot system according to claim 60, wherein said secondary data line has a main section and a modification section structurally modified compared to said main section, and said modification section is said impedance modification element.

62. The robot system according to claim 60, wherein said secondary track has said secondary data line.

63. The robot system according to claim 60, wherein said at least one secondary drive element and/or said secondary drive tooth profile contain said secondary data line.

64. The robot system according to claim 60, wherein said at least two secondary guides and/or said secondary guide tooth profile of one of said at least two secondary guides contains said secondary data line.

65. The robot system according to claim 55, wherein said movable robot has an energy supply element configured to receive electrical energy, and said communication device is configured to use a frequency for the data communication, at which said energy supply element acts as a radio-frequency idle state.

66. The robot system according to claim 55, further comprising a position determination device configured to determine a position of said movable robot within the robot system and said position determination device is configured to determine a position of said movable robot when said movable robot is at a standstill.

67. The robot system according to claim 66, wherein said position determination device is configured to determine the position of said movable robot via said data line.

68. The robot system according to claim 66, wherein said track has a modular structure formed of a plurality of interconnected track modules.

69. The robot system according to claim 68, wherein said track modules are telescopically and/or foldably connected to each other.

70. The robot system according to claim 68, wherein said position determination device is configured to determine a track module position of least one of said track modules.

71. The robot system according to claim 38, wherein the robot system and/or said movable robot has/have a sensor which is configured to detect alignment errors of the robot system and/or to detect wear of a component of the robot system and/or of said movable robot.

72. The robot system according to claim 71, wherein said sensor is a laser distance measurement sensor and/or a force sensor and/or a strain sensor and/or an inertial sensor and/or a laser position sensor.

73. The robot system according to claim 38,
further comprising an additional robot; and
wherein said movable robot has an additional track guiding said additional robot during movement with at least two additional guides,
wherein said additional track has at least one additional drive element with an additional drive tooth profile, and said additional robot contains at least one additional drive wheel which is operatively connected to an additional motor drive unit of said additional robot and engages in said additional drive tooth profile during a movement of said additional robot in said additional track.

74. A method of using a robot system, which comprises:
proving the robot system according to claim 38; and
using the robot system in a construction automation system.
